(19) United States
(12) Patent Application Publication
(10) Pub. No.: US 2015/0262468 A1
(43) Pub. Date: Sep. 17, 2015

(54) POWER SOCKET TEMPERATURE ALARM DEVICE

(71) Applicant: WEI-LI YANG, New Taipei City (TW)

(72) Inventor: WEI-LI YANG, New Taipei City (TW)

(21) Appl. No.: 14/207,657

(22) Filed: Mar. 13, 2014

(51) Int. Cl. G08B 21/18; G08B 7/06

(52) U.S. Cl. CPC G08B 21/182; G08B 7/06

(57) ABSTRACT

A power socket temperature alarm device includes a casing, a power socket module received in the casing, a plurality of temperature detection elements, a processing circuit module, at least a lighting alarm element, and at least a sound alarm element. The temperature detection elements are set in contact with the power socket module and the temperature detection elements are in information connection with the processing circuit module. The processing circuit module is operatively connected with the lighting alarm element (for indicating the site of a hazard) and the sound alarm element (for giving off a signal of the hazard). When the power socket module receives a plug inserted therein and supplies electrical power thereto, the temperature will be gradually increased and the temperature detection elements are separately activated. Status variation of the temperature detection elements activates the processing circuit module to give off flashing light and mutually different sounds.

### TECHNICAL FIELD OF THE INVENTION

The present invention generally relates to a power socket including temperature-triggered audio alarm, and more particularly to a power socket temperature alarm device that provides multiple stages of safety alarm.

### DESCRIPTION OF THE PRIOR ART

A power cord is generally a common name for a power extender that has a plug and multiple outlets in electrical connection with the plug or simply a length of a power cable, both being commonly considered belonging to the field.

The earliest version of the power cord is simply an extension cable for the purposes of extending length and it has gradually evolved in the functionality thereof by including a switch, a one-to-multiple extender, a timer, a voltage/current display. All these help improve the functionality of the power cord, making the use thereof more and more convenient.

In the known devices, a safety arrangement is often employed, wherein the physical property that heat will be generated when electricity flows through an object is used for safety management. When a problem occurs in the use or operation thereof, such as overloading or a poor contact, rise of operation temperature will definitely result. Under this condition, protection can be realized through detection of the temperature so as to for example cut of the power supply or lower down the electrical output to thereby prevent the occurrence of any crisis. However, this often causes a serious problem. When power is cut off instantaneously, all the electrical devices that are connected to the circuit receiving the power supply will be forced to stop operation, leading to unexpected damage, such as unsaved computer data or interruption of operations that cannot be interrupted. Since the variation of temperature is generally a continuous process, it is generally impossible to have an abrupt rise of temperature. The current practice for handling this problem by simply cutting off the power supply may not be a perfect strategy.

Thus, it is desired to provide a solution to overcome the above problems.

### SUMMARY OF THE INVENTION

In view of the above problems, the present invention aims to provide a power socket temperature alarm device that provides multiple stages of safety alarm.

The primary object of the present invention is that a plurality of temperature detection elements is provided for individually detecting the operation temperature of a power socket module. When the temperature rises, the output status of the temperature detection elements is changed so as to activate a processing circuit module, whereby in response to the current situation of detected temperature, the processing circuit module makes a lighting alarm element and a sounding alarm element to respectively give off lighting and flashing and multiple stages of alarm sounding to notify a user of the current hazard situation and give the user a sufficient period of time to handle the hazard. With such an arrangement, the problem of the conventional extension power cord that electrical power supplied therethrough may be abruptly cut off can be overcome and a practical advantage of multiple stages of safety alarming can be achieved.

To achieve the above object, the present invention provides a power socket temperature alarm device, which generally comprises a casing and the casing receives a power socket module, a plurality of temperature detection elements, a processing circuit module, at least a lighting alarm element, and at least a sound alarm element mounted therein in such a way that the temperature detection elements are in contact with the power socket module and the temperature detection elements are in information connection with the processing circuit module. A change in temperature will causes variation of output and the lighting alarm element and the sound alarm element are caused to operate in connection with the processing circuit module so that according to the output of the temperature detection elements, the processing circuit module generate different statuses where the sound alarm element gives off multiple stages of sounding that are mutually different for alarming and at the same time, the lighting alarm element is caused to give of lighting and flashing so as to achieve the purposes of multiple-stage safety alarming. With the above described structure and operation, a user does not need to concern about abrupt cut-off of power supply in the use of electrical power, and when temperature gradually rises, the temperature detection element is subjected to activation of the first stage, wherein the lighting alarm element is put into operation and gives of lighting and flashing and the sound alarm element gives off sounding of a moderation volume to notify the user to proceed with proper handling, and if the temperature continuously rises up, activation of a second stage is carried out to require for immediate handling of the current hazard situation. The sounding will be de-activated when the temperature goes down.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a schematic view showing inside details of the preferred embodiment of the present invention.

FIG. 3 is a block diagram of the preferred embodiment of the present invention.

FIG. 4 is a perspective view illustrating an operation of the preferred embodiment of the present invention.

FIG. 5 is another perspective view illustrating an operation of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

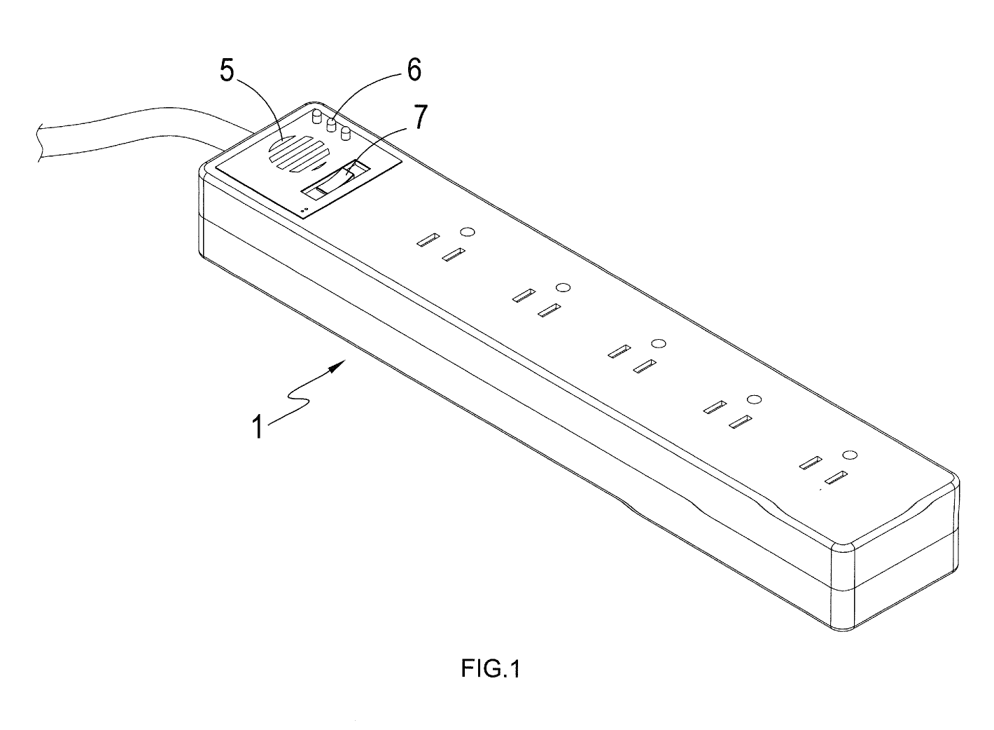

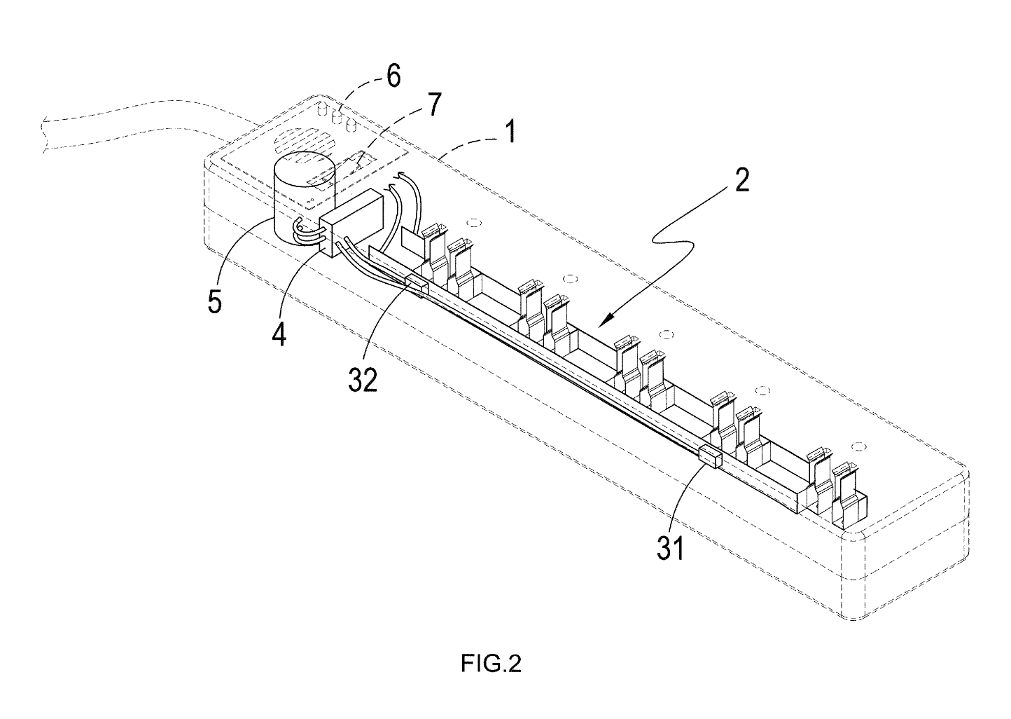

Referring to FIGS. 1, 2, and 3, which are respectively a perspective view showing a preferred embodiment of the present invention, a schematic view showing inside details of the preferred embodiment of the present invention, and a block diagram of the preferred embodiment of the present invention, the drawing clearly show that the present invention comprises:

a casing, wherein the casing 1 comprises a switch element 7 mounted to one side thereof;

a power socket module 2, which is received in the casing 1 and electrically connected to the switch element 7;

a plurality of temperature detection elements, which is set in contact with the power socket module 2;

a processing circuit module 4, which is received in the casing 1 and is in information connection with the temperature detection element;

at least one sound alarm element 5, which is received in the casing 1 and is operatively connected with the processing circuit module 4 to selectively carry out multiple stages of alarm sounding that are different; and

at least one lighting alarm element 6, which is received in the casing 1 and is operatively connected with the processing circuit module 4 to generate alarm lighting and flashing.

The temperature detection element further comprises a first temperature detection element 31 and a second temperature detection element 32.

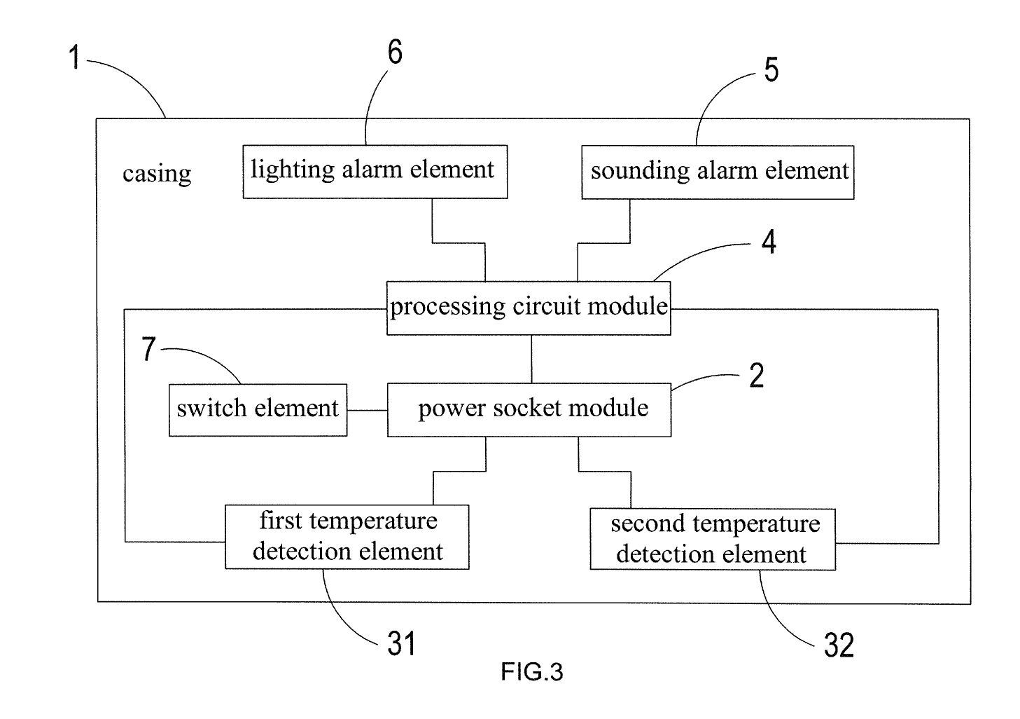

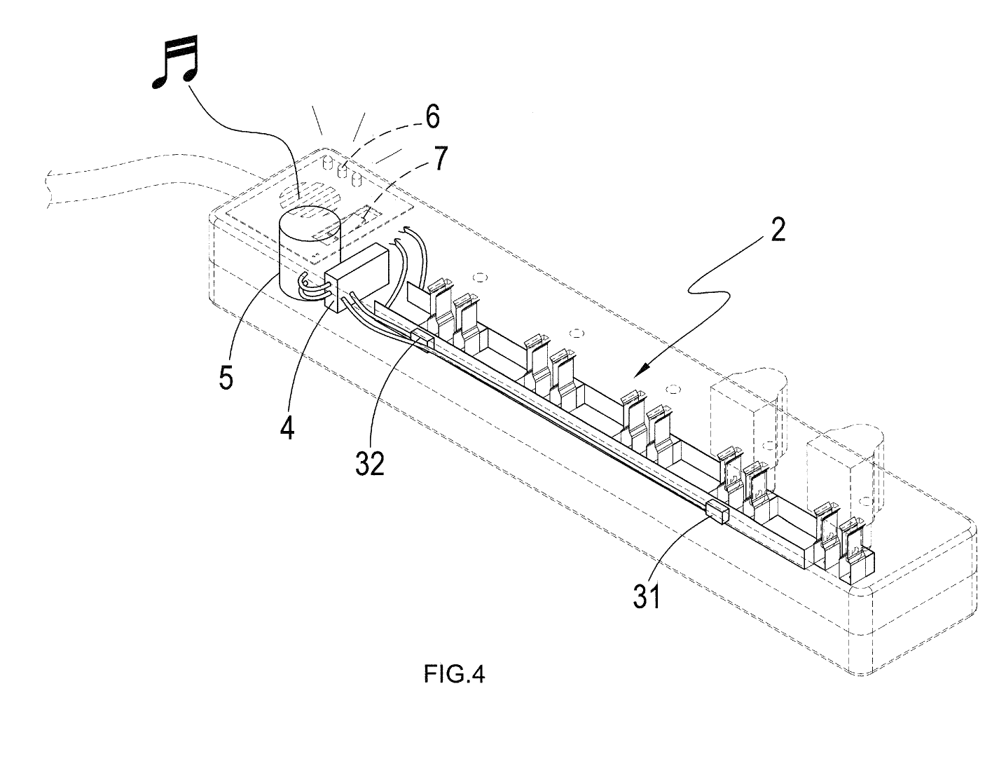

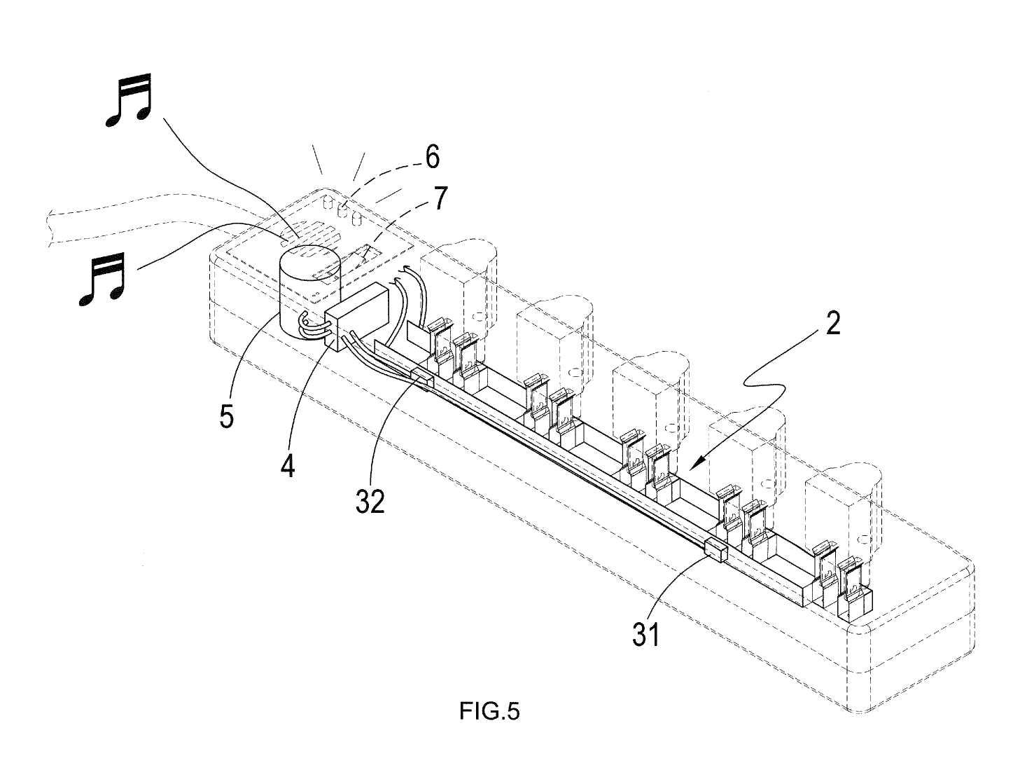

Referring collectively to FIGS. 3, 4, and 5, which are respectively the block diagram of the preferred embodiment of the present invention, a perspective view illustrating an operation of the preferred embodiment of the present invention, and another perspective view illustrating an operation of the preferred embodiment of the present invention, the drawing clearly show that, in practice, the present invention is used in exactly the same way as a conventional power extender cord, where a plug is plugged into the power socket module 2 and then the switch element 7 is actuated on/off to control the supply or shut-off of electrical power. When electrical power is supplied, since the plug is put in contact with the power socket module 2, due to the physical property of electrical current, the electrical current that is conducted through the power socket module 2 generates heat, leading to a rise of temperature. Under a normal condition, the temperature will not unduly rise and thus, it does not causes activation of the temperature detection element; in a condition of long term use or poor heat dissipation, as well as aging of components, temperature will rise undesirably and under this condition, the first temperature detection element 31, which has a relatively low operation temperature, will actuate the processing circuit module 4 first so that the processing circuit module 4 transmits such an output condition to the sound alarm element 5 and the lighting alarm element 6 to generate sounding of low pitch and flashing light to notify a user of alarming and location. This is a first-stage situation and the user is given sufficient time to end the operation or job that he or she is currently doing and then handle the temperature rising problem, as illustrated in FIG. 4. If the situation is not properly handled or the temperature rises very quickly, the second temperature detection element 32 is then caused to operate and the operation of the second temperature detection element 32 is similar to what described above and activate the processing circuit module 4, but the difference is that the second temperature detection element 32 has a relatively high operation temperature that is higher than that of the first temperature detection element 31, indicating the situation to be handled is a more hazard situation, so that the processing circuit module 4 outputs a condition, which is different from the previous one, to the sound alarm element 5, making louder sounding to warn and notify the user to immediately handle the abnormal temperature so as to prevent the occurrence of any dangerous problem, as illustrated in FIG. 5. The description provided above, in respect of the structure and operation of the present invention clearly show that the features of the present invention are that multiple temperature detection elements are provided in the casing 1 to carry out temperature detection is multiple stages, so that the sound alarm element 5 may vary the output for multiple stages to clearly notify the user of the current situation and prevent occurrence of dangerous situations so that the user may have sufficient to complete the job that he or she is doing and a practical advantage of multiple stages of alarming can be achieved.

Thus, the key technical features that the power socket temperature alarm device according to the present invention adopts to overcome the drawbacks of the prior art are as follows:

Multiple temperature detection element are provided for independently carrying out detection and are respectively associated with sounding of different decibels so as to provide multiple stages of output that have mutually different sounding to clearly notify the user of the current dangerous situations thereby achieving multiple stages of safety alarming. Further, the structure described above is simple and the manufacture thereof is easy.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power socket temperature alarm device, comprising:
a casing;
a power socket module, which is received in the casing;
a plurality of temperature detection elements, which is individually in contact with the power socket module;
a processing circuit module, which is received in the casing and is in information connection with the temperature detection element;
at least one lighting alarm element, which is received in the casing and is operatively connected with the processing circuit module to provide an alarm of lighting and flashing; and
at least one sound alarm element, which is received in the casing and is operatively connected with the processing circuit module to provide multiple stages of alarms of different sounding.

2. The power socket temperature alarm device according to claim 1, wherein the temperature detection element comprises a temperature switch.

3. The power socket temperature alarm device according to claim 1, wherein the temperature detection element comprises a first temperature detection element and a second temperature detection element.

4. The power socket temperature alarm device according to claim 3, wherein the sound alarm element is operable in connection with the first temperature detection element to carry out a first sage of alarm of sounding and the sound alarm element is operable in connection with the second temperature detection element to carry out a second stage of alarm of sounding.

5. The power socket temperature alarm device according to claim 4, wherein the first stage of alarm of sounding has a decibel value that is greater than that of the second stage of alarm of sounding.

6. The power socket temperature alarm device according to claim 1, wherein the power socket module comprises at least one power socket.

7. The power socket temperature alarm device according to claim 1, wherein the power socket module is operatively connected with a switch element that turns on/off and switches the circuit.
